(19) United States
(12) Patent Application Publication
(10) Pub. No.: US 2009/0030193 A1
(43) Pub. Date: Jan. 29, 2009

(54) Synthesis of Vilsmeier Haack Reagent from Di(Trichlo-Romethyl) Carbonate for Chlorination Reaction

(75) Inventors: Rakesh Ratnam, Maharashtra (IN); Sundeep Aurora, Maharashtra (IN); Shrikant Kulkarni, Maharashtra (IN)

Correspondence Address: THE NATH LAW GROUP, 112 South West Street, Alexandria, VA, 22314, US

(73) Assignee: PHARMED MEDICARE PRIVATE LIMITED, Mumbai (IN)

(21) Appl. No.: 11/919,827

(22) PCT Filed: Apr. 28, 2006
(86) PCT No.: PCT/IN2006/000152

§ 371 Date: Nov. 29, 2007

(30) Foreign Application Priority Data
May 4, 2005 (IN) 546/MUM/2005

(51) Int. Cl. C13K 13/00

(52) U.S. Cl. 536/123.13

(57) ABSTRACT

A process of preparation of Vilsmeier-Haack reagent is provided where di(trichloromethyl) carbonate reacts with N,N-dimethylformamide to form a Vilsmeier reagent, which can be used efficiently for chlorination of sucrose-6-acetate or sucrose-6-benzoate and other sucrose acylates. This process has application in the process for preparation of 1-6-Dichloro-1-6-DIDEOXY-β-Fructofuranasyl-4-chloro-4-deoxy-galactopyranoside.

### TECHNICAL FIELD

The present invention relates to a process and a novel strategy for synthesis of Vilsmeier-Haack reagent and chlorination of sucrose or their derivatives for production of chlorinated compounds of sucrose including 1′-6′-Dichloro-1′-6′-DIDEOXY-β-Fructofuranasyl-4-chloro-4-deoxy-galactopyranoside (TGS) and the like.

### BACKGROUND OF THE INVENTION

Strategies of prior art methods of production of 4,1′, 6′ trichlorogalactosucrose (TGS) predominantly involves use of Vilsmeier-Haack reagent to chlorinate Sucrose-6-ester, mainly Sucrose-6-acetate to form 6 acetyl 4,1′, 6′trichlorogalactosucrose which is deesterified/deacetylated in the reaction mixture itself to form TGS.

Mufti et al (1983) in U.S. Pat. No. 4,380,476 claimed chlorination of monoacylates of sucrose by Vilsmeier reagent formed from reaction of PCl₅ with the appropriate tertiary amide.

The general formula of Vilsmeier reagent, irrespective of source of chlorinating reagent used, remained same as described by Mufti et al i.e. an N,N-dialkyl-(chloromethaniminium) chloride of the general formula:

[XCIC=N.sup.+R.sub.2]CI.sup.−

where R represents an alkyl group, typically a methyl or ethyl group, and X represents a hydrogen atom or a methyl group.

Mufti et al further pointed out that, reagents of this type are prepared by reaction of an inorganic acid chloride with an N,N-dialkylformamide or N,N-dialkylacetamide. The inorganic acid chloride may typically be phosphorous pentachloride, phosgene, or thionyl chloride.

Vilsmeier reagent formation was also reported by Jenner et al (1982) in U.S. Pat. No. 4,362,869, GB No. 2 182 039, GB 2 222 827, GB No. 2 079 749 and GB No. 2 145 080 from Thionyl chloride. Rathbone et al (1986) in U.S. Pat. No. 4,617,269 described Vilsmeir reagent from Phosphorus Pentachloride. Walkup et al (1990) in U.S. Pat. No. 4,980,463 reported Vilsmeier reagent from phosgene, Phosphorus Oxychloride, Phosphorus Pentachloride, Pspsphorus Iminium Chloride, Oxalyl Chloride and thionyl chloride.

Thus, so far Vilsmeir reagent was produced by reacting N,N-dimethylformamide (DMF) or N,N-dialkylacetamide with an acid chloride.

It was a totally unanticipated and surprising invention that a chloroalkyl carbonate, which is not an acid chloride, reacted with DMF to form a Vilsmeier reagent, which is the subject matter of this specification. It has further been found to be a very efficient way of preparing a Vilsmeier reagent.

### SUMMARY OF INVENTION

When a Chloroalkyl carbonate such as di(trichloromethyl) carbonate is taken in an inert solvent and added to a base such as at controlled temperature, Vilsmeier-Haack reagent was seen to be formed in the form of insoluble crystals separating out from the reaction mixture. This Vilsmeier reagent is seen to be capable of chlorinating substrates such as sucrose-6-acylates just as Vilsmeier reagent generated by prior art methods i.e. from reaction of DMF and any acid chloride It is for the first time that a Vilsmeier reagent is being formed by reacting with DMF a chemical which is not an acid chloride. This gives a new and a more efficient way of using Vilsmeier-Haack reagent to chlorinate sucrose, its derivatives and for analogous chlorination reactions through the synthesis and application of Vilsmeier-Haack reagent.

### DETAILED DESCRIPTION OF THE INVENTION

In this entire specification, including claims, it is understood that a singular also includes plural, unless context indicates otherwise. Thus, for example “an acid chloride” includes one or more of all the known acid chlorides. Further, the examples given are only for the purpose of illustration of the working of this invention and actual chemicals used, their proportions and reaction conditions used are not mentioned to limit the scope of invention and the claims. Anything that is equivalent or an adaptation of the claims and obvious to an ordinary person skilled in this art is included within the scope of this specification.

A Chloroalkyl carbonate such as di(trichloromethyl) carbonate is taken in toluene and reacted with DMF. In place of toluene it is possible to use any other inert solvent including but not limited to cyclohexane, hexane, heptane, ethylene chloride, xylene, chloroform, perchloroethylene and the like. In place of DMF it is possible to use any other tertiary amide such as N,N-dialkylformamide or N,N-dialkylacetamide.

The Vilsmeier-Haack reagent formed in the process described in this invention is in solid form and is contacted with the substrate to be chlorinated using DMF as the solvent. The chlorination reaction was carried out by heating the reaction mixture to elevated temperatures and maintaining them at various points for required period of time and then neutralized at the end of the reaction by an appropriate base.

The invention is illustrated by following examples:

### EXAMPLE 1

130 ml of DMF was taken in a three necked round bottom flask and was cooled to −4° C. A solution containing sucrose-6-acetate, 10 g equivalent dissolved in 30 ml of DMF was added to the above mentioned reaction flask. Then, the di(trichloromethyl) carbonate solution, prepared by dissolving 25 gm of di(trichloromethyl) carbonate in 100 ml of dry toluene was taken in the addition funnel and added into the reaction flask below 0° C. with constant stirring. The formation of the Vilsmeier Haack reagent in the flask is spontaneous and further immediately reacts with sucrose-6-acetate in the reaction flask. After the addition was completed the reaction was allowed to attain ambient conditions and stirred for 30 min. The reaction mixture was heated to 80° C., maintained for 1.0 hr, further heated to 120° C. maintained for 4 hr. The reaction mass was cooled to 60° C. and neutralized to 7-7.5 using calcium hydroxide slurry. The HPLC analysis for the formation of 6-O-acetyl 4,1′,6′trichlorogalactosucrose was carried out and was found to be 35% of sucrose input.

### EXAMPLE 2

800 ml of DMF was taken in a three necked round bottom flask and was cool to −4° C.

The di(trichloromethyl) carbonate solution in Perchloroethylene (150 gm in 500 ml.) was taken in the addition funnel and added into the reaction flask below 0° C. with constant stirring. The formation of the Vilsmeier Haack reagent was seen in the form of white crystals in the reaction flask. After the addition of the di(trichlormethyl) carbonate solution, the sucrose-6-benzoate (60 g of sucrose equivalent) in DMF was added to the above reaction flask below 0° C.

The reaction was allowed to attain ambient conditions and stirred for 30 min. The reaction mixture was heated to 80° C., maintained for 1.0 hr, further heated to 120° C. maintained for 4 hr. The reaction mass was cooled to 60° C. and neutralized to 7-7.5 using calcium hydroxide slurry. The HPLC analysis for the formation of 6-O-acetyl 4,1′,6′trichlorogalactosucrose was carried out and was found to be 45% of sucrose input.

1. A process of preparing Vilsmeier-Haack reagent comprising reacting one or more of a Chloroalkyl carbonate with a tertiary amide either in absence of substrate to be chlorinated or in presence of a substrate to be chlorinated dissolved in a tertiary amide, wherein the said Chloroalkyl carbonate has general formula X₃R—CO—O—CO—RX₃ where R=alkyl group, and X=a halogen such as chlorine, bromine, iodine and the like.

2. A process of claim 1 wherein the said Chloroalkyl carbonate comprises di(trichloromethyl) carbonate of chemical formula Cl₃C—CO—O—CO—CCl₃; the said tertiary amide comprises one or more of N,N-dialkylformamide or N,N-dialkylacetamide, more preferably N,N-dimethylformamide
(DMF); the said substrate comprises a sucrose acylate, more preferably a sucrose monoacylate, still more preferably a sucrose-6-acylate, further more preferably sucrose-6-acetate or sucrose-6-benzoate.

3. A process of claim 2 comprising dissolving di(trichloromethyl) carbonate in an inert solvent, preferably toluene, and reacting the same with DMF either:
a. in absence of any substrate, when the Vilsmeier reagent precipitates out which is applied in chlorination reaction before or after isolating it from the DMF, or
b. in presence of sucrose-6-acetate or sucrose-6-benzoate dissolved in DMF.

4. A process of chlorination comprising reacting Vilsmeier reagent prepared by the process of claim 1 with a substrate comprising one or more of a sucrose acylate, further comprising one or more of a sucrose mono acylate, still further comprising one or more of a sucrose-6-acylate, preferably comprising sucrose-6-acetate or sucrose-6-benzoate further comprising steps of:
a. a reaction mixture is stirred for a period of time, preferably for about 30 minutes to one hour, the said reaction mixture comprising either,
i. a solution of the said Vilsmeier reagent brought in contact with the said solution of sucrose-6-acetate or sucrose-6-benzoate taking care not to allow the temperature of the solution to rise preferably above ambient, or,
ii. sucrose-6-acetate or sucrose-6-benzoate dissolved in DMF,
b. temperature raised to about 80° C. and maintained for a period of time, preferably for one hour,
c. temperature raised further to about 120° C. and maintained for a period, preferably for about four hours; and
d. neutralized to a pH of about 7 to 7.5 using a base, preferably calcium hydroxide slurry.

5. A process of preparation of 1-6-Dichloro-1-6-DIDEOXY-β-Fructofuranasyl-4-chloro-4-deoxy-galactopyranoside by chlorinating sucrose-6-acetate or sucrose-6-benzoate comprising use of Vilsmeier reagent prepared by process of claim 1 by a process of chlorination.

6. A process of chlorination comprising reacting Vilsmeier reagent prepared by process of claim 3 with a substrate comprising one or more of a sucrose acylate, further comprising one or more of a sucrose mono acylate, still further comprising one or more of a sucrose-6-acylate, preferably comprising sucrose-6-acetate or sucrose-6-benzoate further comprising steps of:
e. a reaction mixture is stirred for a period of time, preferably for about 30 minutes to one hour, the said reaction mixture comprising either,
i. a solution of the said Vilsmeier reagent brought in contact with the said solution of sucrose-6-acetate or sucrose-6-benzoate taking care not to allow the temperature of the solution to rise preferably above ambient, or,
ii. sucrose-6-acetate or sucrose-6-benzoate dissolved in DMF,
f. temperature raised to about 80° C. and maintained for a period of time, preferably for one hour,
g. temperature raised further to about 120° C. and maintained for a period, preferably for about four hours; and
h. neutralized to a pH of about 7 to 7.5 using a base, preferably calcium hydroxide slurry.

7. A process of preparation of 1-6-Dichloro-1-6-DIDEOXY-β-Fructofuranasyl-4-chloro-4-deoxy-galactopyranoside by chlorinating sucrose-6-acetate or sucrose-6-benzoate comprising use of Vilsmeier reagent prepared by the process of claim 3 by a process of chlorination.

8. A process of preparation of 1-6-Dichloro-1-6-DIDEOXY-β-Fructofuranasyl-4-chloro-4-deoxy-galactopyranoside by chlorinating sucrose-6-acetate or sucrose-6-benzoate comprising use of Vilsmeier reagent prepared by the process of claim 4.
